(19) United States
(12) Patent Application Publication
(10) Pub. No.: US 2006/0045321 A1
(43) Pub. Date: Mar. 2, 2006

(54) Bank check and method for positioning and interpreting a digital check within a defined region

(75) Inventor: Gregory J. Yu, San Mateo, CA (US)

Correspondence Address: Gregory J. Yu;Chen-Yu Enterprises LLC, Suite P-1, 2015 Pioneer Ct., San Mateo, CA, 94403, US

(73) Assignee: Chen-Yu Enterprises LLC

(21) Appl. No.: 10/926,485

(22) Filed: Aug. 24, 2004

(51) Int. Cl. G06K 9/00

(52) U.S. Cl. 382/137

(57) ABSTRACT

This invention adds new markings to an original check face prior to tender and processing of the check. These markings, when digitally scanned from the original, are readily interpreted and preserved. During the process of truncating the original with image replacement documents (IRDs) that are the legal equivalent, the new markings solve two major problems when the IRDs are formally introduced into the clearinghouse channel. First, the clipped image of the original check can be properly aligned within a designated region within the IRD based on the uniform markings. Second, data content aligned in reference to the uniform markings preserved in the IRD process can be properly recognized and read as if the software was scanning the original physical document.

### CROSS-REFERENCES TO RELATED APPLICATIONS

Not Applicable

### FEDERALLY SPONSORED RESEARCH

Not Applicable

### SEQUENCE LISTING OR PROGRAM

Not Applicable

### 37 C.F.R. 1.71 AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office records, but otherwise reserves all copyright rights whatsoever.

### BACKGROUND

1. Field of Invention

The present invention relates to a method of imprinting a bank check with special markings to improve the processing of the check and the delivery of extracted data back to the drawee bank and the drawer.

2. Description of Prior Art

Bank Checks

Checks are a special commercial instrument used by household and businesses to make payments. Standards promulgated by the American National Standards Institute provide relative uniformity to stock quality, dimension, design and printing to make the processing of checks through the financial clearinghouse more streamlined and efficient. When paid and cleared through the system, each check must be pre-encoded by the payer or encoded by the depositary bank to allow expedited and machine-driven processing of the check. The magnetic ink character recognition line (MICR) sets forth on each check the payer bank's routing number, the checkwriter's account no., the check number and the check amount.

Printed checks come in a variety of styles, designs, and features. Some come with elaborate scenery, graphic arts design, and logos in the background of the basic elements of the check. Most of the designs are printed to create loyalty of the check writer toward a design, message or company. Certain designs include a printed border around the perimeter of the check, but they are used for decorative and cosmetic purposes and not for functional utility in the processing and imaging of the check.

Commercial banks have begun to collect and pay checks by transmitting and exchanging a digital image of the original check, instead of physically transporting the original check to the forwarding bank. Physical transportation according to tight regulated deadlines each night creates an additional cost for commercial banks to pay checks. Digital exchange of check images reduces that cost, but each participating bank must acquire operational capability to exchange digital images. These are the subject of private agreements among exchanging banks.

Congress and the Federal Reserve determined that the payments system could be made more efficient and secure by encouraging the use of digital check image exchange and by allowing paying and forwarding banks to reduce the frequency and urgency of overnight original check return in order to get paid. The solution was the “Check Clearing for the 21^{st} Century Act” (the “Check 21 Act”) became federal law on Oct. 28, 2003 and is effective one year thereafter. The Check 21 Act allows a depository bank and intermediary banks to truncate and replace the original check with an image replacement document (IRD) or a “substitute check” that conforms to certain legal standards. The receiving and forward collecting bank must accept the instrument in the same manner as if it were receiving the original check itself.

Standards for the Substitute Check

The relevant portion of the Check 21 Act defined a “substitute check” as “a paper reproduction of the original check that (A) contains an image of the front and back of the original check; (B) bears a MICR line containing all the information appearing on the MICR line of the original check, except as provided under generally applicable industry standards for substitute checks to facilitate processing of substitute checks; (C) conforms, in paper stock, dimension, and otherwise, with generally applicable standards for substitute checks; and (D) is suitable for automated processing in the same manner as the original check.”

While the Check 21 Act promises savings in the transportation of the original check, it contemplates the widespread destruction of the original check as a legal order to pay of the check writer. That means that the key article of evidence of payment, signature, and authenticity for the payment is eliminated from the normal course of clearing, dispute resolution and litigation. To alleviate the loss of legal evidence from the payment stream, the Check 21 Act requires that a “substitute check shall be the legal equivalent of the original check for all purposes . . . if the substitute check (1) accurately represents all of the information on the front and back of the original check as of the time the original check was truncated, and (2) bears the legend: ‘This is a legal copy of your check. You can use it the same way you would use the original check.’”

The obvious danger and risk posed by substitute check creation is that there may be certain material and content appearing or affixed on the original that cannot be or is not actually replicated or reproduced on the substitute check. For example, there are payee and official bank endorsements of the paying and forwarding banks and other parties that handle the check. In addition, certain security features are lost when the original is destroyed. Endorsements must be imprinted on the substitute check so that the newly created substitute check “is suitable for automated processing in the same manner as the original check.” This is precisely why Congress expected the industry to produce proper standards to insure some degree of uniformity and predictability in the use, processing and acceptance of substitute checks as legal tender.

The Accredited Standards Committee X9 (the “X9 Committee”) has promulgated a number of industry standards to promote the efficient use and processing of paper checks within the payments system of the United States. These standards promote uniformity in check design and production, including: ANS X9.18-1998, Paper Specifications for Checks (being renumbered as X9.100-010; ANS X9.13-1999, Specifications for Placement and Location of MICR Printing (being renumbered as X9.100-160); ANS X9.7-1999, Bank Check Background and Convenience Amount Field (being renumbered as X9.100-030 and X9.100-110). In addition, there is a Technical Guideline for paper check design, known as X9-TG-2-R-1995.

In 2004, the X9 Committee released ANS X9.100-140 for review and approval by its members, which includes retailers, corporations, financial institutions, and manufacturers and vendors that supply financial equipment, software and stock and systems to create substitute checks. ANS X9.100-140 presents “Specifications for an Image Replacement Document—RD” (“IRD Specs”). Since the IRD, or a “substitute check” needs to be honored and paid by institutions handling the item during downstream processing, the successful implementation of the Check 21 Act requires a properly designed and functioning substitute check.

IRD Specs, FIG. 1, show the IRD—Master Layout, Front with eight separate regions. The region of interest is 1F, as shown in FIG. 1. The fundamental purpose of the IRE or substitute check is to accurately represent all of the information on the front and back, which is best achieved by a faithful and complete digital image of the original check's front and back. Since the other regions of interest occupy designated space of the IRD, Region 1F is the area where the front image of the original check is to be inserted. This Region measures 5.750 inches wide by 2.750 inches high (IRD Spec, Clause 6.1.1, p. 5). The clipped image is to maintain the same height and width proportion as the original check, so as to avoid distortion of the content and characters contained on the original check.

When a document is scanned to be converted into a digital image, there are generally two different formats. The first is a gray-scale image that captures various shades of coloration appearing on the original documents. When the image is digitized, there are various shades of gray shown on the digital image. The second format is black-and-white. For each x-y coordinate on the document, the location is either empty or contains a black pixel. During the document capture and digital conversion process, the digital image may suffer from forward or reverse tilting or skewing. There could be background noise on the document that leads to extraneous pixilation on the digital image. Also there could be loss of digitization due to high tolerance to register a pixel in a given x-y coordinate. All these contribute toward the degradation of the digital image.

The consistency and reliability in the production and use of the IRD depends in part on whether the clipped image is placed in the correct location each time an IRD is produced. Therefore, IRD Specs establish an “Image Anchor Point” as defined in Clause 4.8, which “[r]epresents the starting X and Y point of origin for printing a digital image. This image anchor point for the lower right hand corner of the clipped image is 0.7175 inches above the aligning edge (Clause 4.1) and 0.25 inches from the leading edge (Clause 4.12). Content or printing of any sort must stay completely clear of the “No Print Area” which is the top 0.1995 inches of the IRD. This insures that when IRDs are printed and separated serially with the perforated edge, no printing or characters will encroach on the “clear band” (Clause 4.3) where the MICR line resides along the aligning edge of the preceding IRD. The “No Print Area” is a reference dimension with no tolerance.

Since there is no margin of error for placing a clipped image in Region 1F too high and into the “No Print Area”, it is crucial that the image begin and be anchored at the “image anchor point”. In addition, the creation of digital images and printing them onto paper poses the risk of skewing or tilting of the image reproduced onto a paper document. That is, there could be either “forward” or “backward” tilt in the image during the initial imaging of the original check or in the clipping and pasting of the image in an initial or subsequent creation of IRD for the original check. Therefore, the IRD Specs recommend that the “document image shall be oriented so that written information is in its normal orientation.”

The Challenge of Placement of Clipped Images in Region 1F

To a large extent, the processing and handling of IRDs is no different than the processing and handling of original checks today. Occasionally, a check will not be read or processed correctly, which then requires “exceptions processing” and perhaps human or operator intervention. When a bank system or operator has to process an IRD, the clipped image may not squarely fall within Region 1F and actually encroach upon other protected regions or spaces of the IRD, such as the “No Print Area”. The creation institution or a bank that handles of an IRD downstream will need to determine if the image lines up properly with the “image anchor point”. If it does not, there is a direct violation of the IRD Specs and, more importantly, a possible violation of Section 3(16) of the Check 21 Act.

The core value of the Check 21 Act is efficiency in both processing IRDs and check payments and in prompt resolution among parties and institutions that handle IRDs. If conformity to the law, the regulations or ANSI standards is not readily measurable, this only creates dangerous uncertainty as to which party in the processing of an IRD is at fault. The destruction of the original check by the creation institution makes the conformity, accuracy and uniformity of the IRD that much more vital to minimizing potential disruptions from item processing, IRD handling and customer or bank dispute resolution.

Establishing the location of the image anchor point is only done visually with a reference point off the IRD, whether the aligning edge or leading edge of the physical border of the IRD, or a registration or reference point or mark. The test would determine if the clipped image does indeed lock itself to the standard image anchor point in the lower right corner of Region 1F.

It would at first appear that placing a black border around the perimeter of Region 1F of the IRD would provide a means to test whether the clipped image rested without the bounds of Region 1F. However, the accurate placement of such a border is a function of two parameters. First, the print machine feeder or the offset printing equipment must be able to print documents and its content at the precise location on the stock paper. The second factor is the precision at which the paper stock is cut or perforated. Either of these processes could produce a flawed border location and accordingly, a misplaced image anchor point.

Other required content in the various regions located on the IRD according to the Check 21 Act and the IRD Specs face no special burdens or circumstances in printing. All such content is not replicated from a pre-existing document but constitutes freshly minted and generated printed characters. For example, the machine-readable clear band contains the MICR line of characters in Region 5F, and the clipped image can in no way encroach on this sacrosanct region reserved for the MICR line. Regions 2F and 3F contain the routing numbers of the Check Truncation Institution and the Creation Institution, respectively.

The clipped image of the original check as placed there by the first creation institution is much the same as a digital image of a portrait. If there is no horizontal or vertical border on the perimeter of a portrait, painting, or check, the only means to test for proper placement is a visual extrapolation of whether the image is properly aligned with a particular physical edge of the IRD, or is accurately hinged to the image anchor point. A subsequent creation institution must accurate locate Region 1F of the existing substitute check and paste the exact same check image into Region 1F of the newly created substitute check. However, if the original check image has no visual pre-existing border, the subsequent institution is left to estimate or approximate where the actual borders of the existing clipped image lie on the substitute check.

Due to the lack of a precise means to determine where to print the image anchor point so that the clipped image is indeed affixed to the image anchor point, a more reliable means to secure the clipped image to that point and later match the lower right corner of the image to the virtual image anchor point becomes necessary. Without is a clear, definable human-readable corner point to the clipped image, there are three problems. First, the creation institution has no effective means to verify whether the black-and-white or gray-scaled check image is indeed affixed to the image anchor point. Second, a forwarding institution that handles the IRD has no means to assess whether the IRD contains a properly aligned clipped image that correctly resides within Region 1F according to the IRD Specs. Third, if a forwarding institution reconverts an existing IRD, absent its possession of a clean, scrubbed digital image of the original, the institution will lack any reliable, definable border or reference point to extract and transfer the clipped image into the new IRD. This inexorably leads to unintentional, and perhaps deleterious, cropping of one or more borders of the clipped image, as well as greater skewing, mishandling or misalignment of the original check image. The quality, reliability and utility of the clipped image within the IRD are bound to suffer. Further, as the clipped image's quality suffers, so will that of the IRD itself. This will lead to breach of the substitute check warranties, indemnification and increased litigation among the processing banks and the consumer herself.

The Check 21 Act will effectively deny the drawee bank or the drawer guaranteed access to the original check document. Certain security anti-fraud features based on ink printing, watermarking and paper quality will be lost without access to the original. In addition, as check items will undergo one or more reconversions with multiple substitute checks, the original placement of the check on a piece of payment will be altered. Also, the resolution appearing on each subsequent clipped check image may lose pixel quantity and concentration. Existing image recognition solutions will be unexpectedly compromised. One example is the signature verification based on a clear, clean image of the original signature on the original check. Another is optical character recognition of the courtesy amount for encoding and balancing purposes. A third is the reading of expense categorization content under U.S. Pat. No. 5,433,483. Obviously, when the region of interest in image recognition is shifted on the physical document (as is the case for an IRD), or image quality deteriorates (as might be the case of a multiple IRD'd check item), the algorithms must be modified and new parameters must be introduced to continue a minimum level of accuracy in the software.

In the past, the MICR line was been used in various image recognition applications as a reference point for the algorithms. When the region of interest has now been shifted upward from the newly created MICR line on the IRD, and the entire image downsized to fit within Region 1F, significant software modifications are absolutely necessary.

U.S. Pat. No. 5,020,434 to Copham (1991) uses borders and patterns to assist in creating pre-printed check stock. However, this invention focuses only on stacking and collating print stock for the binding of checks of varying styles in a consistent sequence. Image recognition is not contemplated. U.S. Pat. No. 5,085,587 to DesForges (1992) uses control marks, but they are rectangular and used for a scannable form and not a bank check. U.S. Pat. No. 5,347,302 (1994) utilizes a series of indicator base marks on printed laser checks, but only for the purpose of accurately printing content onto check stock in the proper location. Such content includes the MICR line and predefined rectangular regions. These indicator marks include the use of perforations of the paper stock and bracket lines.

U.S. Pat. No. 6,155,604 to Greene et al. (2000) describes the use of florescent and phosphorescent ink undetectable by the human eye in rectangular layouts to define a region to be imaged on the face of the check. U.S. Pat. No. 6,315,329 to Greene (2001) also uses special ink that is scannable, but not visible to the naked eye. Neither of these patents address the use of black ink along the border of the check as indicia or registration marks.

U.S. Pat. No. 6,654,487 to Downs, Jr. (2003) is an automated check analysis method that relies on both MICR and non-MICR characters to image content within a check image.

U.S. Pat. No. 6,766,056 to Huang et al. (2004) discloses a method to image a document to detect a predetermined mark as a reference point to locating an overall picture or image; this document (as is the case for an IRD), or image quality deteriorates (as might be the case of a multiple IRD'd check item), the algorithms must be modified and new parameters must be introduced to continue a minimum level of accuracy in the software.

In the past, the MICR line was been used in various image recognition applications as a reference point for the algorithms. When the region of interest has now been shifted upward from the newly created MICR line on the IRD, and the entire image downsized to fit within Region 1F, significant software modifications are absolutely necessary.

U.S. Pat. No. 5,020,434 to Copham (1991) uses borders and patterns to assist in creating pre-printed check stock. However, this invention focuses only on stacking and collating print stock for the binding of checks of varying styles in a consistent sequence. Image recognition is not contemplated.

U.S. Pat. No. 5,347,302 (1994) utilizes a series of indicator base marks on printed laser checks, but only for the purpose of accurately printing content onto check stock in the proper location. Such content includes the MICR line and predefined rectangular regions. These indicator marks include the use of perforations of the paper stock and bracket lines.

U.S. Pat. No. 6,155,604 to Greene et al. (2000) describes the use of florescent and phosphorescent ink undetectable by the human eye in rectangular layouts to define a region to be imaged on the face of the check. U.S. Pat. No. 6,315,329 to Greene (2001) also uses special ink that is scannable, but not visible to the naked eye. Neither of these patents address the use of black ink along the border of the check as indicia or registration marks.

U.S. Pat. No. 6,654,487 to Downs, Jr. (2003) is an automated check analysis method that relies on both MICR and non-MICR characters to image content within a check image.

U.S. Pat. No. 6,766,056 to Huang et al. (2004) discloses a method to image a document to detect a predetermined mark as a reference point to locating an overall picture or image; this does not relate to checks or substitute checks and placing marks to recognize and interpret characters or markings.

U.S. Patent Application no. 20040148235 of Mark S. Craig, et al., published on Jul. 29, 2004, describes a system for check image exchange through an image exchange network such that the system emulates the item processing system in time and effect for original item capture and forwarding to the payer bank. There is no modification to the payments system to use a newly designed original instrument to enhance the process of allowing a paying or collecting bank to present an alternative to the original check if no such image exchange arrangements are in place between the various banks.

U.S. Patent Application no. 20040068464 of Danne Buchanan et al., published Apr. 8, 2004, describes a method and system for using electronic notification files to process return items using check image exchange. The embodiment of this proposed invention contemplates the use of “image replacement document” to allow the process of Return Item Early Notification to take place between the returning bank and the crediting bank. While this proposed invention facilitates the use of electronic return item image exchange, it does not claim a system or device to make the handling of return items between the returning institution and intermediate institutions more efficient with a utility or modified print feature on the original check.

All existing printed checks are subject to truncation under the Check 21 Act. Various prior art includes various security and encryption features to verify or validate the payment, e.g., U.S. Pat. Nos. 6,155,604 and 6,315,329. However, neither of these contemplated the advent of substitute checks and the need to enhance the use or facilitate the production and ongoing utility of check images within an IRD. Once the original check is truncated, the only apparent connection is the affixing of the routing number of the creation institution onto the IRD and the replication of the MICR line from the original check. The placement of the digital image of the original onto the IRD within Region 1F is the responsibility of the creation institution. There is no efficient means for a downstream bank to test whether the image is properly clipped and inserted onto the IRD.

Overall, the prior art lends no design or functionality to original check manufacture that would enhance or enable greater ease, utility or accuracy arising from the subsequent creation of an IRD based on the original check.

### SUMMARY OF THE INVENTION

It is an object of the present invention to enhance the legibility and uniformity of the substitute check, as created by financial institutions pursuant to the Check 21 Act. After creating each substitute check within the check clearing process, the creating institution that truncates the original check would be able to visually and programmatically test the newly created substitute check to see that the clipped image of the original check is properly placed and aligned within Region 1F of the substitute check.

It is a further object of the present invention to assist all downstream forward collecting banks that receive an IRD or a forward subsequent IRD to visually and programmatically determine if the clipped image of the original check rests in the proper location and orientation according to the correct aspect ratio and alignment with the edges of Region 1F of the IRD. If there is noticeable degradation, tilt or other deterioration in the quality of the clipped image, such subsequent banks can more readily determine if the check image is indeed legible and otherwise complies with the warranties given by all creating institutions upstream as to the legal equivalence of the IRD being collected.

It is still another object to more readily enable various application software recognition solutions to perform accurate or more satisfactory image recognition of various data content lifted from either the original check or a faithful, properly positioned, industry standard-compliant placement and sizing of the digital image of the original check that resides in an IRD, for the benefit of banks and customers. This requires standard registration or reference points that first appear preprinted on the original check and survive the image reproduction process caused by creating new IRDs for the same check item.

### DRAWINGS

In the drawings, closely related figures have the same number but different alphabetic suffixes.

FIG. 1 displays the current version of the Image Replacement Document—Master Layout, Front, as proposed by ANSI under ANS x9-100-140-2004.

FIG. 2A is a layout of the substitute check created, using a personal-sized original check that contains a preferred embodiment of the present invention.

FIG. 2B is a layout of the substitute check created, using a business-sized original check that contains a preferred embodiment of the present invention.

FIG. 3A is a layout of the substitute check created, using a personal-sized original check that contains an alternative embodiment of the present invention.

FIG. 3B is a layout of the substitute check created, using a business-sized original check that contains an alternative embodiment of the present invention.

FIG. 4A is a diagram of a substitute check containing a clipped image of the preferred embodiment as a personal check.

FIG. 4B is a diagram of a substitute check containing a clipped image of the preferred embodiment as a business check.

FIG. 5A is a diagram of a substitute check containing a clipped image of the alternative embodiment as a personal check.

FIG. 5B is a diagram of a substitute check containing a clipped image of the alternative embodiment as a business check.

FIG. 6A shows a substitute check showing a clipped image of a personal check with registration marks on the border to enable a scanner to locate and interpret markings made by the check writer for a category of household expenses.

FIG. 6B shows a substitute check showing a clipped image of a business check with registration marks on the border to enable a scanner to locate and interpret markings made by the check writer for a category of business expenses.

FIG. 7 is a flowchart that shows how subsequent IRDs flow from, and are created by, original IRDs that use, in part, area 11 from the original IRD to be inserted as a newly scanned digital image of the original check into area 11 of the subsequent IRD.

### DETAILED DESCRIPTION OF THE INVENTION

The Figures depict preferred embodiments of the present invention for purposes of illustration only. One skilled in the art will readily recognize from the following discussion that alternative embodiments of the structures and methods illustrated herein may be employed without departing from the principles of the invention described herein.

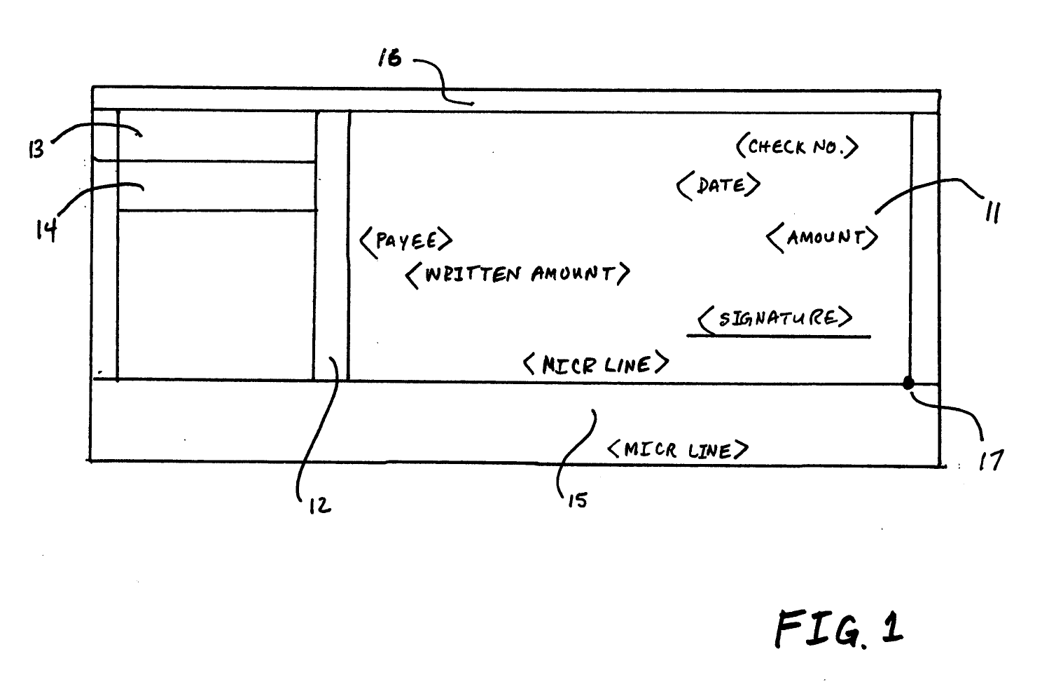

FIG. 1 shows the layout of selected regions contained in the substitute check as presented by the X9 Committee. The following layout and specifications are exclusively under the design and control of the X9 Committee. Each Region is referred to in the IRD Specs as “Region [#], immediate followed by an “F”. Area 11 is the rectangular space for Region 1F, which contains a clipped image of the original check that is truncated by a creation institution. The physical dimension of Area 11 is to be 5.750 inches wide by 2.750 inches high. Area 12 is Region 2F, which includes, among other data, the bank routing number of the financial institution that has custody of the original check and later truncates that check. Area 13 is Region 3F, which contains the routing number of the institution that creates the substitute check. Area 14 is Region 4F, that sets for the legal equivalence legend for the substitute check as required by the Check 21 Act. Area 15 is Region 5F, known as the MICR clear band, which is space reserved for the MICR line encoded onto the substitute check. This line is distinct from the imaged MICR line in Area 11 where the clipped image of the original resides. Area 16 is an empty bar at the top edge of the substitute check that cannot have any printing. This is just under the perforation on the physical substitute check that is printed within a series of substitute checks, one above the other, on laser print stock. Point 17 is the image anchor point that is found 0.25 inches from the leading or right edge of the substitute check and 0.7175 inches above the aligning edge or bottom edge of the check. Point 17 is where the bottom right corner of the clipped image of the original check is to be fixed or anchored. The image anchor point would be automatically printed during the printing of the raw paper stock used for substitute checks, or during the actual creation and printing of a substitute check.

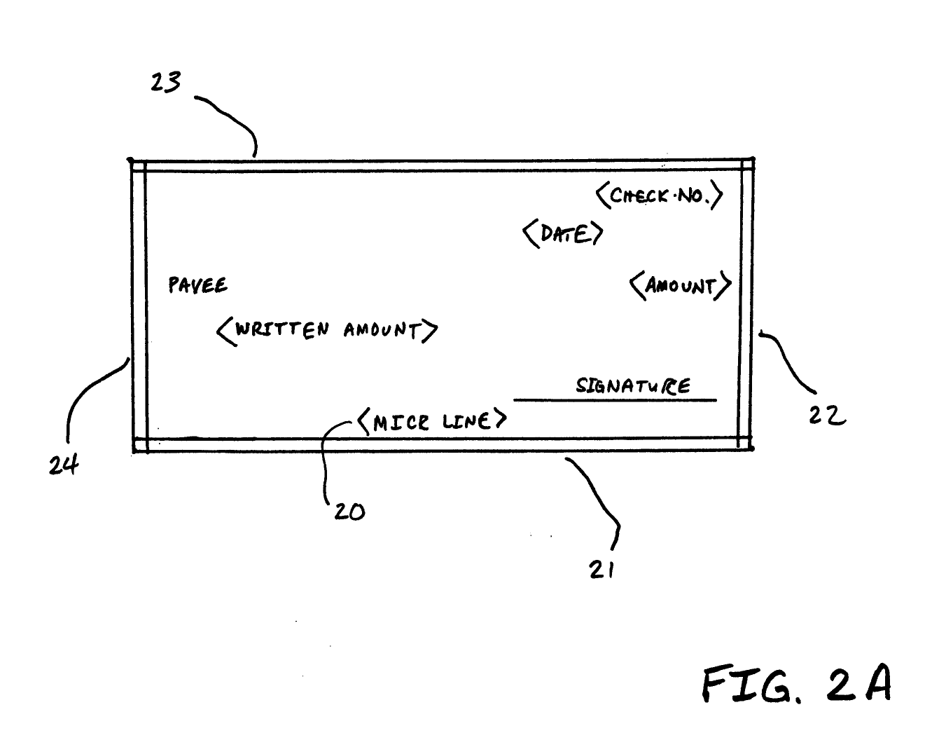

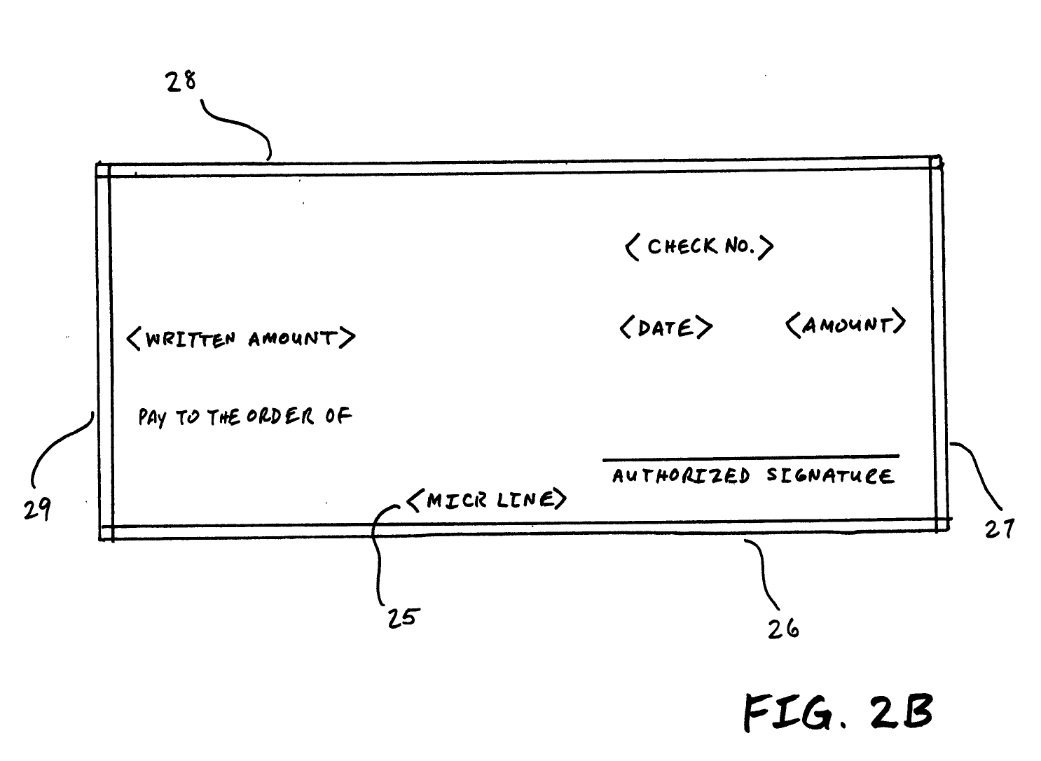

In the preferred embodiment, FIG. 2A and FIG. 2B show how the original check, personal-size and business-size, respectively, is printed with a darkened border around the perimeter of the check prior to check processing. The border does not touch MICR line 20 in FIG. 2A or MICR line 25 in FIG. 2B. The personal check border has completely contiguous, but identified in four portions, segment 21 for the bottom edge, segment 22 for the right or leading edge, segment 23 for the top edge, and segment 24 for the trailing or left edge. Each of segments 21, 22, 23 and 24 are tangential to the extreme edge its respective side of the check. Likewise, the business check in FIG. 2B has a printed border comprised of segment 26 for the bottom edge, segment 27 for the right or leading edge, segment 28 for the top edge, and segment 29 for the trailing or left edge. When the IRD is produced with the clipped image of the preferred embodiment, the image of the personal check can be accurately inserted inside area 11 using point 17 of the substitute check in FIG. 1. The border comprised of segments 21, 22, 23, and 24 outlines the entire dimension of the original personal check. Likewise, when the IRD is produced with a clipped image of a business check, the image can be outlined using segments 26, 27, 28, and 29 in FIG. 2B. In each case, the creation institution has a clear reference point and border for the placement of the clipped image inside of area 11. The solid perimeter around the four sides of the image facilitates an determination of whether the insertion of the clipped image conforms to the master layout and dimensions for utilizing Region 1F under the IRD Specs.

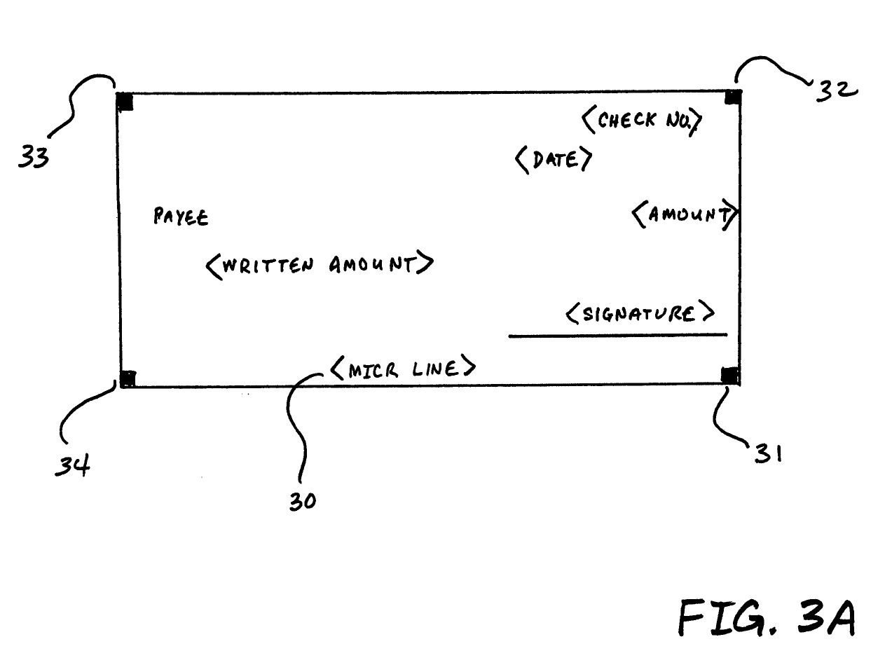

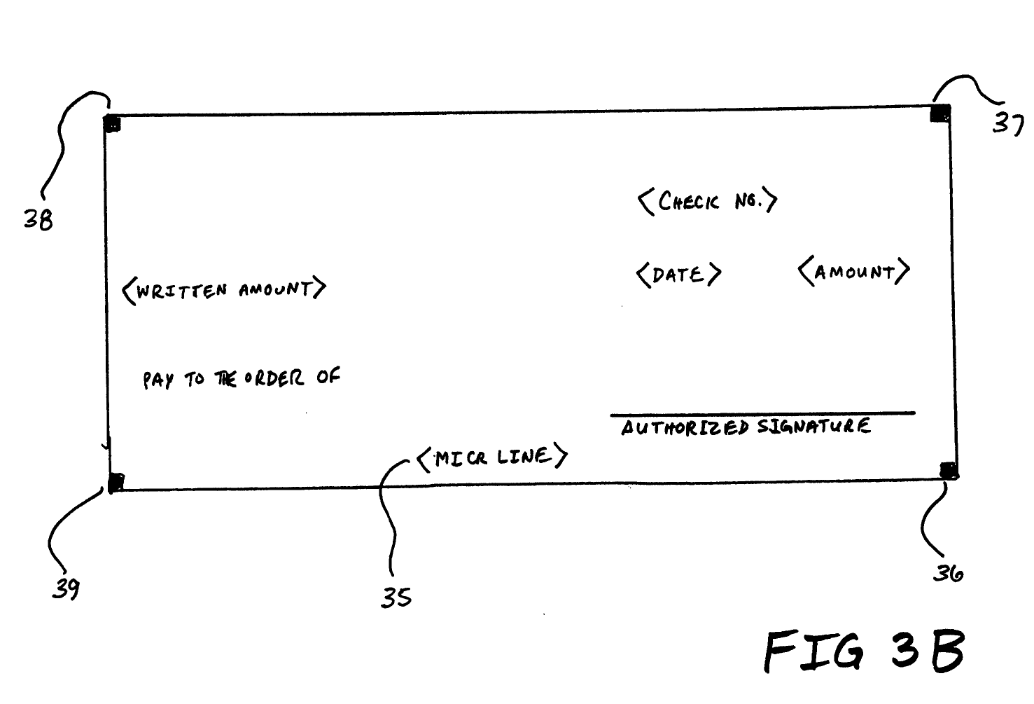

In an alternative embodiment, darkened uniform marks in the shape of a square are fixed in each corner of the original check, whether personal-sized in FIG. 3A, or business-sized in FIG. 3B. In FIG. 3A, mark 31 is tangential to the corner where the leading and aligning edges meet; mark 31 is where the leading and top edges meet; mark 33 is where the top and trailing edges meet; and mark 34 is where the trailing and aligning edges meet. Likewise, for the business-sized check in FIG. 3B, mark 36 is tangential to the corner where the leading and aligning edges meet; mark 37 is where the leading and top edges meet; mark 38 is where the top and trailing edges meet; and mark 39 is where the trailing and aligning edges meet. In one sense, marks in the alternative embodiment is less intrusive to the human eye that the darkened segments around the entire border of the preferred embodiment. Also, there is much less risk that marks 31 and 34 would encroach on any content of MICR line 30 in the personal check in FIG. 3A, and marks 36 and 39 touching any of MICR line 35 in the business check in FIG. 3B. Squares also act as efficient registration marks to allow a software recognition tool to fix a point from which other recognition of pixels within the document image can be searched, located, and properly analyzed.

In the case of both the preferred embodiments in FIGS. 2A and 2B, and the alternative embodiments in FIGS. 3A and 3B, the alignment of the image of the original check assists in creating image statements that appear in a monthly bank statement that returns check images instead of original canceled checks to the drawer customer. Frequently, multiple check images appear in a matrix on white paper to allow the drawee bank to reduce paper and mailing costs. These are letter-sized sheets of 3-hole punched white paper to assist the customer to more organized record keeping. The preferred embodiment invention allows the creator and printer of image statements to more accurately and easily align and print the check images using a visible darkened border along the perimeter of each check. Alternatively, the corner marks of the original check that are preserved in the check image may serve as two reference points for aligning the presentation and printing of the check on the image statement. Where there is electronic delivery of the monthly bank statement, there is a similar need filled to align the check images in normal orientation for the viewer and, consequently, less potential forward or backward skewing of the image.

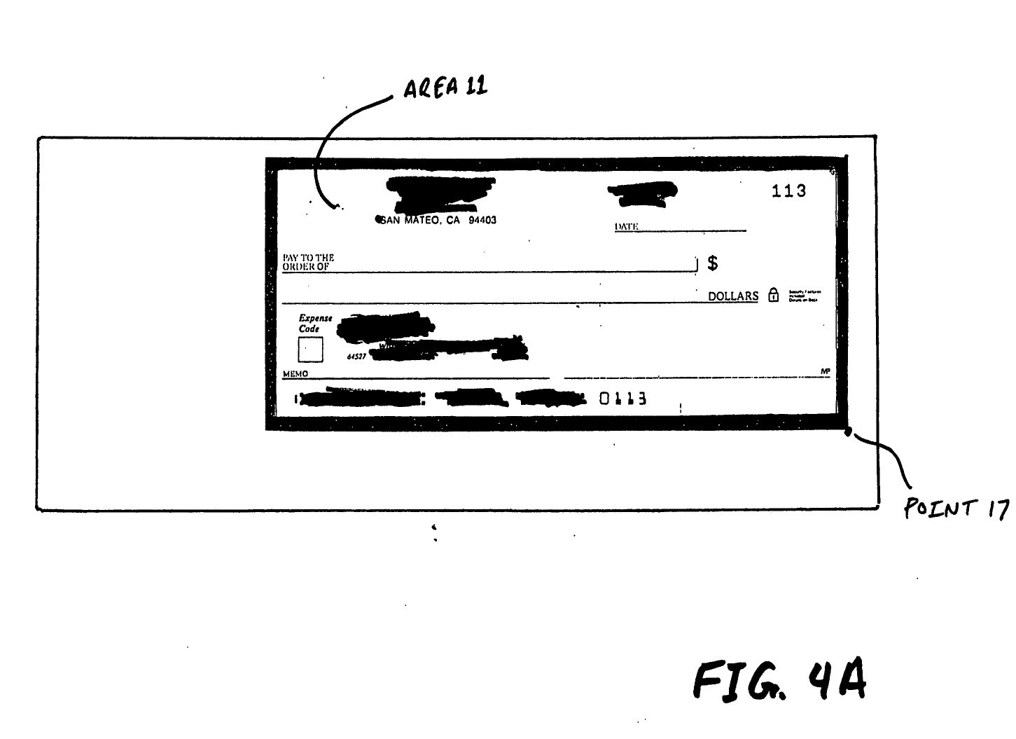

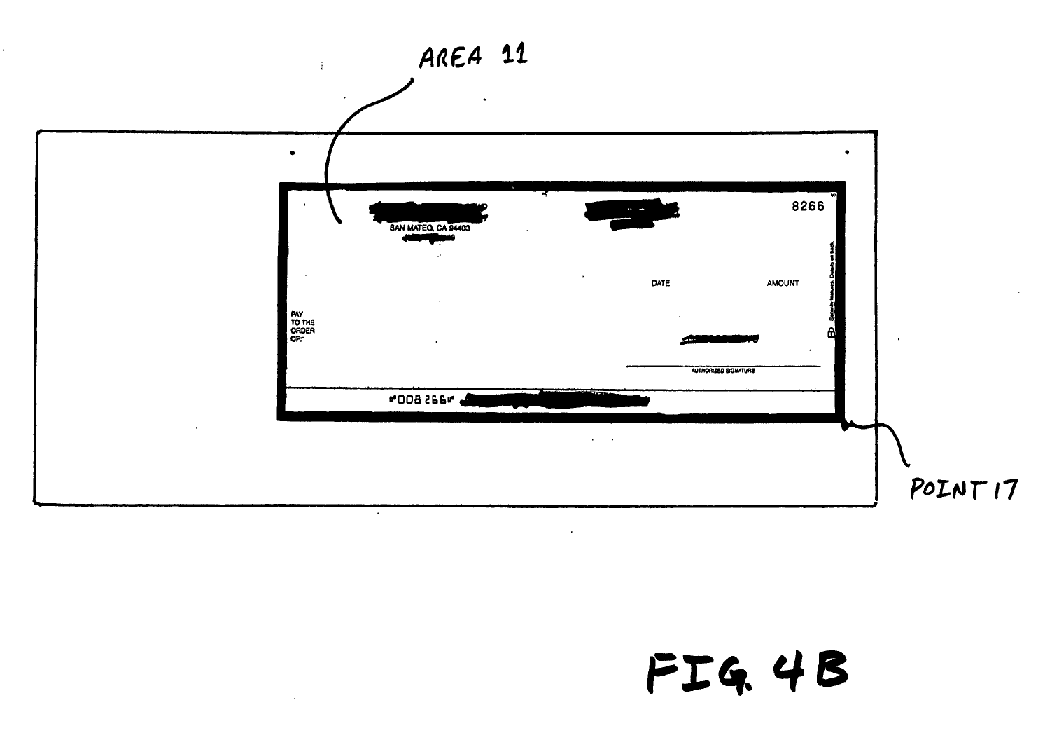

FIG. 4A presents the layout of a substitute check that contains a clipped image of the preferred embodiment as a personal check fitting inside of area 11. The approximate reduction in dimension and size from the original personal check size to the clipped image size is approximately 5%. Point 17 as the image anchor point is shown. FIG. 4B shows the layout of a substitute check with an image of the preferred embodiment as a business check inserted inside of area 11. Here, the approximate reduction in size from the original physical check size to the clipped image size is about 33%. Point 17 as the image anchor point is shown.

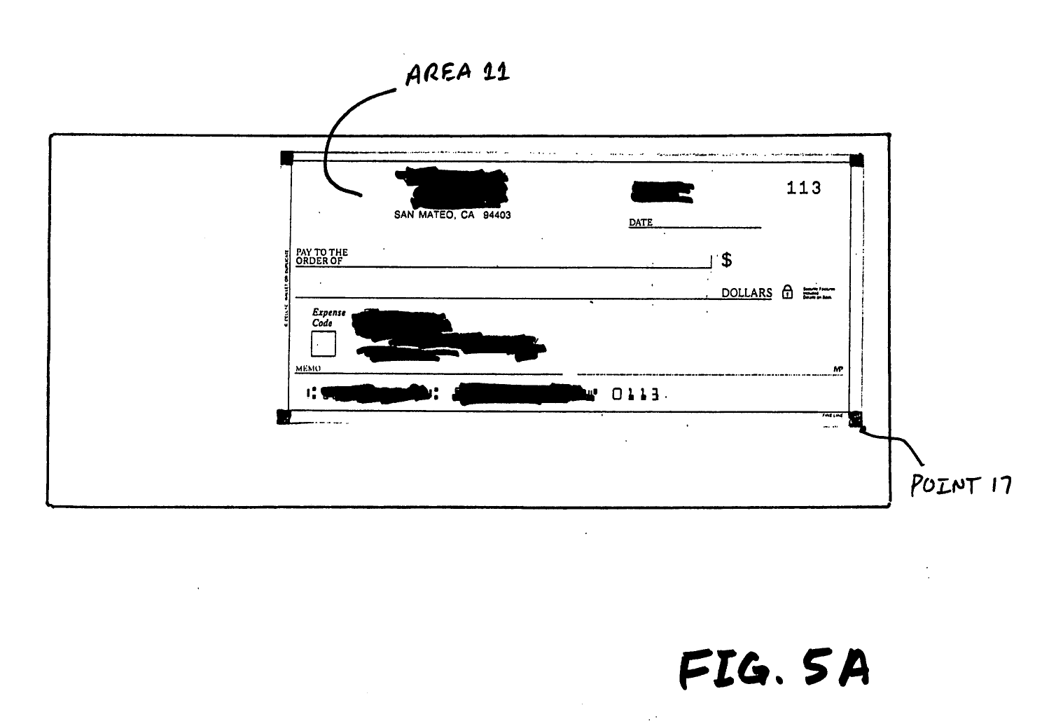

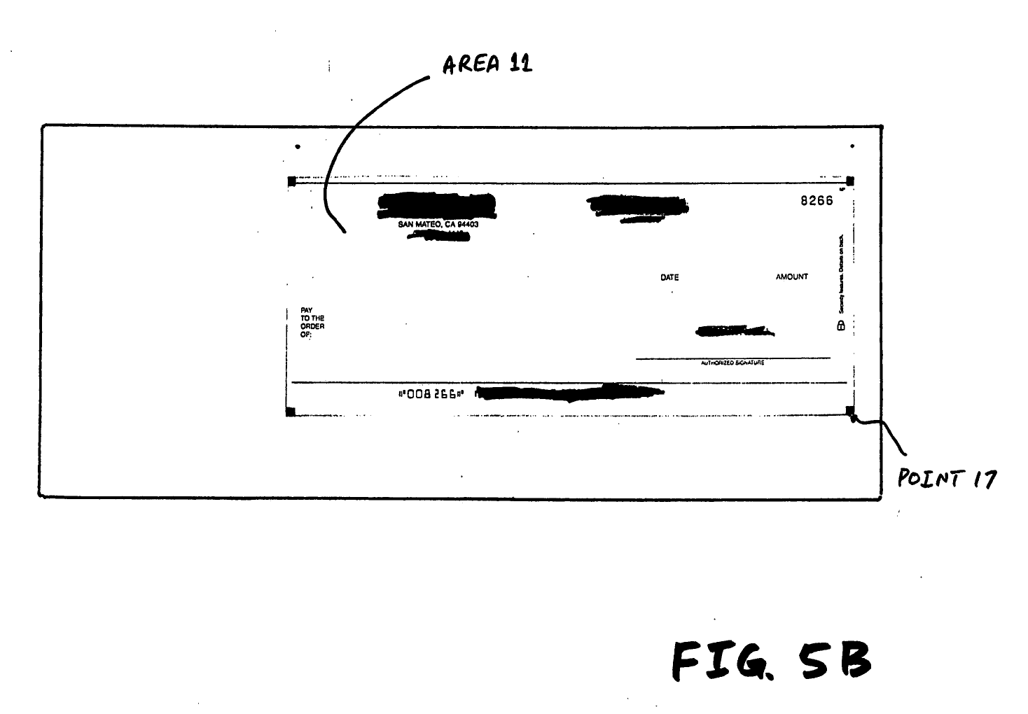

FIG. 5A presents the layout of a substitute check that contains a clipped image of the alternative embodiment as a personal check fitting inside of area 11. The approximate reduction in size of the image is the same as in FIG. 4A. FIG. 5B shows the layout of a substitute check with an image of the alternative embodiment as a business check inserted inside of area 11. The approximate reduction in the size of the image is similar to that in FIG. 5B. Point 17 as the image anchor point for the clipped image is shown in each of FIGS. 5A and 5B.

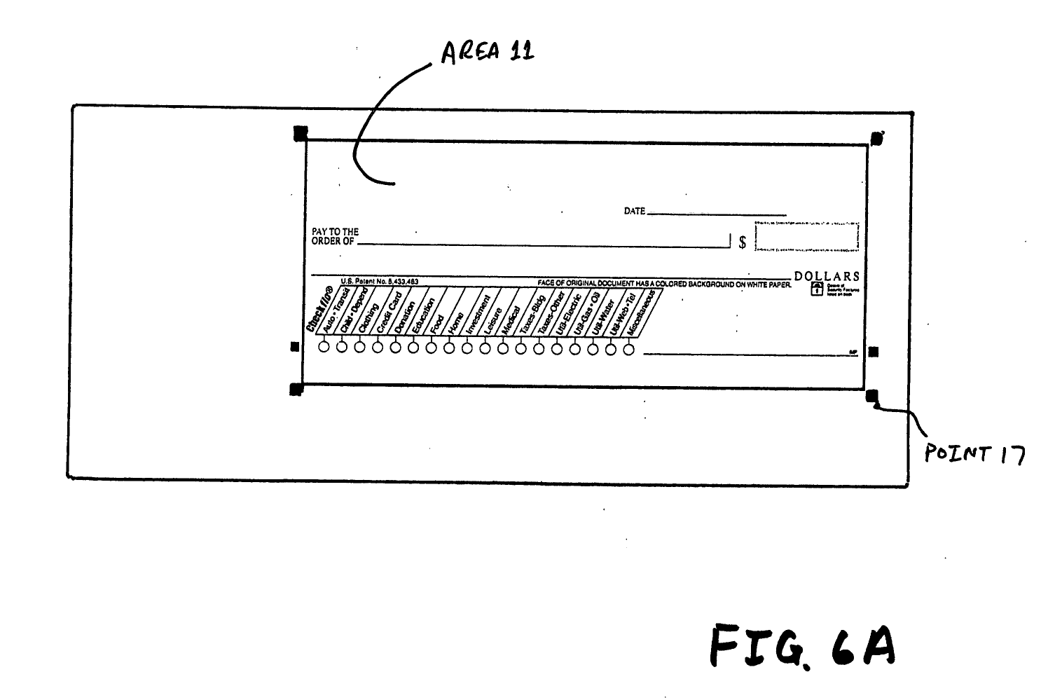

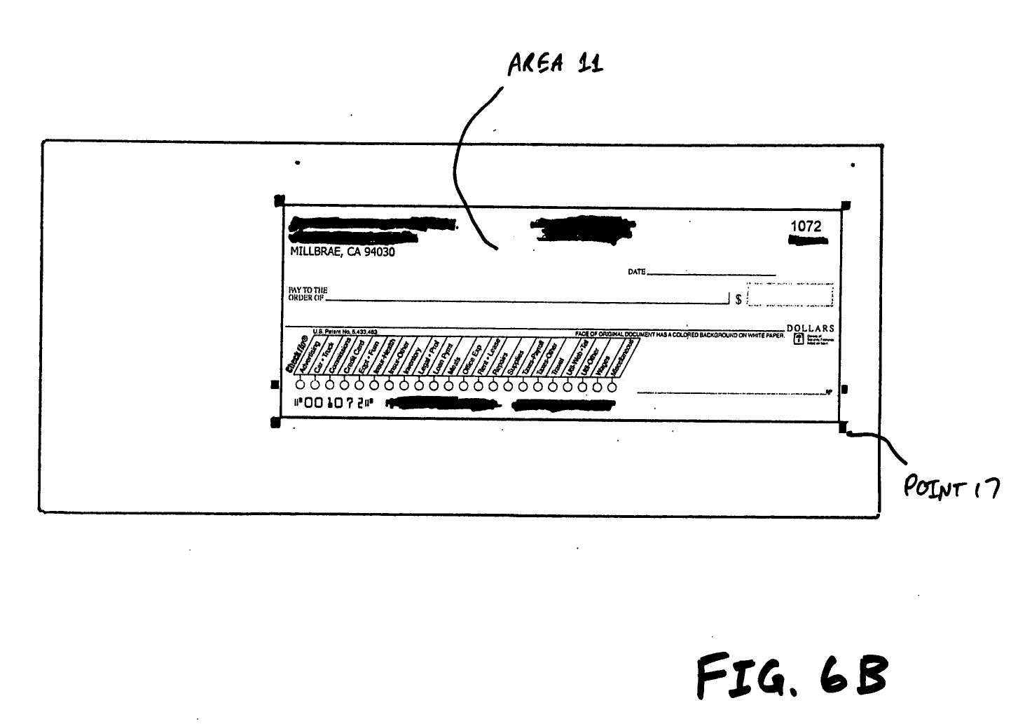

FIG. 6A and FIG. 6B present substitute checks that carry through in the clipped images certain registration marks and corresponding scannable data content appearing on the face of the original personal and business check, respectively. When such content survives in the clipped image, the substitute check can still be used to read, extract and interpret data appearing on a black and white image of the original check. The scanning software would be coded to search for one or more registration marks within the clipped image of the substitute check that are horizontally and/or vertically aligned with target data content.

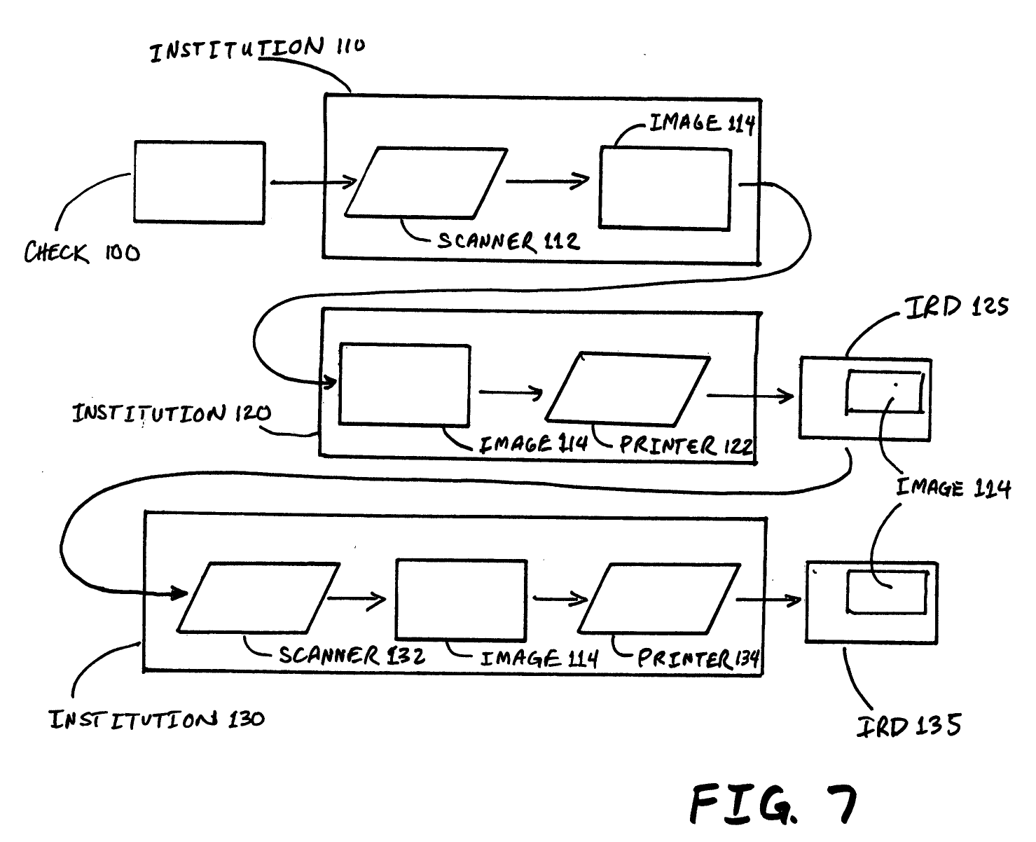

FIG. 7 shows how, under the existing law and art, multiple IRDs of the same check item are created. Original check 100 is deposited in institution 110 as the bank of first deposit. Check 100 is processed through scanner 112 to create image 114. Image 114 is electronically transmitted to the image file of institution 120. Institution 120 uses printer 122 to create original IRD 125. Institution 130 is a collecting bank and opts to use scanner 132 and extract image 114, and then use printer 134 to create subsequent IRD 135. The quality and size of the clipped image 114 appearing inside of IRD 125 and IRD 135 are preserved in this process, even if there may be multiple IRDs created, with the last IRD being presented to the drawee bank and customer. Under this scenario, the utility and features of check 100 in the form of the preferred and alternative embodiments of the present invention are sustained throughout the check clearing process. With the uniform markings in the form of a border or various shapes printed on original checks, the key indicia and registration marks remain on the clipped images inside of area 15.

I claim:

1. A bank check comprising:
a physical paper document containing a set of printed regions to allow a drawer of such check to negotiate an order to pay a payee a legal amount of funds drawn on the account held by the drawer at a financial institution;
a printed, solid border preprinted around the rectangular perimeter of the front of said check such that the outer edge of the border is flush with the extreme edge of all four sides of said check; and
at least one or more segments of said border being operable for permitting a scanner to generate a digital image of the entire front of said check, of a size equal to, smaller than, or greater than, the dimensions of the original of said check or the dimensions of the image of said check appearing on a pre-existing physical document, in normal, original orientation, so that said segments are used to accurately position the entirety of said image in a predefined, standardized location on an electronic document used for printing and returning a physical copy of, or making available for electronic viewing over the worldwide web, a set of digital images of one or more said checks paid by said financial institution on behalf of said drawer.

2. A bank check comprising:
a physical paper document containing a set a printed regions to allow a drawer of such check to negotiate an order to pay a payee a legal amount of funds drawn on the account held by the drawer at a financial institution a legal amount of funds drawn on the account held by the drawer at a financial institution;
a plurality of indicator solid base marks, each in a uniform geometric shape of a square, bar, rectangle, triangle, circle, or similar uniform shape and dimension that is printed in each corner of said check such that each of said marks is tangential to the extreme edge of at least one of the two sides of said check that meet in each corner of said check; and
at least one or more of said marks being operable for permitting a scanner to generate a digital image of the entire front of said check, of a size equal to, smaller than, or greater than, the dimension of the original of said check or the dimensions of the image of said check appearing on a pre-existing physical document, in normal, original orientation, so that said marks are used to accurately position the entirety of said image in a predefined, standardized location on an electronic document used for printing and returning a physical copy of, or making available for electronic viewing over the worldwide web, a set of digital images of one or more said checks paid by said financial institution on behalf of said drawer.

3. A bank check comprising:
a physical paper document containing a set of printed regions to allow a drawer of such check to negotiate an order to pay a payee a legal amount of funds drawn on the account held by the drawer at a financial institution;
a printed, solid border preprinted around the rectangular perimeter of the front of said check such that the outer edge of said border is flush with the extreme edge of all four sides of said check; and
at least one or more segments of said border being operable for permitting a scanner to generate a digital image of the entire front of said check, of a size equal, smaller than, or greater than, the dimensions of the original of said check or the dimensions of the image of said check appearing on a pre-existing physical document, in normal, original orientation, so that the digital image of any one or more of said segments are used to accurately position the entirety of said image in a predefined, standardized location on a newly created, printed image replacement document for the original check or for a previously created image replacement document of the same, which newly created document is used for further downstream processing and return of legally equivalent evidence of the paid check back to the drawer.

4. A bank check comprising:
a physical paper document containing a set a printed regions to allow a drawer of such check to negotiate an order to pay a payee a legal amount of funds drawn on the account held by the drawer at a financial institution a legal amount of funds drawn on the account held by the drawer at a financial institution;
a plurality of indicator solid base marks, each in a uniform geometric shape of a square, bar, rectangle triangle, circle, or similar uniform shape and dimension that is printed in each corner of said check such that each of said marks is tangential to the extreme edge of at least one of the two sides of said check that meet in each corner of said check; and
at least one or more of said marks being operable for permitting a scanner to generate a digital image of the entire front of said check, of a size equal to, smaller than, or greater than, the dimensions of the original of said check or the dimensions of the image of said check appearing on a pre-existing physical document, in normal, original orientation, so that digital images of said marks are used to accurately position the entirety of said image in a predefined location on a newly created, printed image replacement document for the original check or for a previously created image replacement document of the same, which newly created document is used for further downstream processing and return of legally equivalent evidence of the paid check back to the drawer.

5. A method of creating an image replacement document for an original bank check as described in claim 3 comprising the steps of:
a) optically scanning said bank check to generate a digital image;
b) clipping the digital image of said bank check to be inserted inside a predesignated, rectangular region within said image replacement document based on one or more of a plurality of anchor points, each located at a distance measured by a “y” coordinate measured from one or both of the top and bottom edges of said check and by an “x” coordinate measured from one or both of the leading and trailing edges of said check; and
c) aligning said digital image of one or more segments of the solid border captured from said check along the one or more edges of said rectangular region within said image replacement document.

6. A method of creating an image replacement document for an original bank check as described in claim 4 comprising the steps of:
a) optically scanning said bank check to generate a digital image;
b) clipping the digital image of said bank check to be inserted inside a predesignated, rectangular region within said image replacement document based on one or more of a plurality of anchor points, each located at a distance measured by a “y” coordinate measured from one or both of the top and bottom edges of said check and by an “x” coordinate measured from one or both of the leading and trailing edges of said check; and
c) aligning said digital image of one or more indicator solid base marks printed on said check along the one or more edges of said rectangular region within said image replacement document.

7. A bank check comprising:
a physical paper document containing a set of printed regions to allow a drawer of such check to negotiate an order to pay a payee a legal amount of funds drawn on the account held by the drawer at a financial institution;
at least one of a series of marks of uniform shape and dimension, that is printed in each corner of the physical paper check such that said single or series of marks are tangential to the extreme edge of any of one or two sides of said check; and
said check being operable for permitting a scanner to generate a digital image of said check and for allowing a computer to use any one or more of said marks as a reference point to locate and interpret data content within said image that is both detectable by the naked human eye and by machine, which content is in a plurality of forms, including a dot, bubble, stroke, slash, “x”, cross, or alphanumeric character that is intentionally affixed by hand or printed by machine in order to state, indicate or signify a plurality of information about the drawer, the drawee bank, or the payment itself as made by check.

8. The bank check as described in claim 7, whereby said plurality of information includes the postal zip code of the address of the drawer of the check.

9. The bank check as described in claim 7, whereby said plurality of information includes an array of demarcated blank spaces imprinted on the lower left region of said check, with a labeling imprint adjacent to each blank space, each labeling imprint designating an expenditure category distinct from those designated by the other labeling imprints adjacent to the other blank spaces.

10. The bank check as described in claim 9, whereby each said labeling imprint describes a distinct category of household expenditures.

11. The bank check as described in claim 9, whereby each said labeling imprint describes a distinct category of business expenditures.

12. A method of creating an image replacement document from an original bank check comprising the steps of:
a) using a bank check having one or more preprinted marks of uniform shape and dimension flush against the extreme edge of at least one or more of the four sides of the check, whereby each of said marks are preprinted along the top or bottom edges on the same “x” coordinate, within a tolerance of 5%, as that of content to be digitally imaged, read, recognized and interpreted based on pixel concentration and location, and each of said marks are preprinted along the leading or trailing edges on the same “y” coordinate, within a tolerance of 5%, as that of content to be digitally imaged, read, recognized and interpreted based on pixel concentration and location;
b) clipping the digital image of said bank check to be inserted inside a predesignated rectangular region within said image replacement document based one or more of a plurality of anchor points, each located at a distance measured by a “y” coordinate measured from one or both of the top and bottom edges of said check and by an “x” coordinate measured from one or both of the leading and trailing edges of said check; and
c) using a computer to scan said image replacement document and rely upon any one or more of said marks as a reference point to locate and interpret data content within said document that is both detectable by the naked human eye and by machine, which data content is in a plurality of forms, including a dot, bubble, stroke, slash, “x”, cross, or alphanumeric character that is intentionally affixed by hand or printed by machine in order to state, indicate or signify a plurality of information about the drawer, the drawee bank, or the payment itself as made by check.

13. The method as described in claim 12 above whereby said plurality of information includes an array of demarcated blank spaces imprinted on the lower left region of said check, with a labeling imprint adjacent to each blank space, each labeling imprint designating an expenditure category distinct from those designated by the other labeling imprints adjacent to the other blank spaces.

14. The method as described in claim 13, whereby each said labeling imprint describes a distinct category of household expenditures.

15. The method as described in claim 13, whereby each said labeling imprint describes a distinct category of business expenditures.
